(19) United States
(12) Patent Application Publication
(10) Pub. No.: US 2012/0203789 A1
(43) Pub. Date: Aug. 9, 2012

(54) DATA PROCESSING APPARATUS, DATA PROCESSING METHOD, AND STORAGE MEDIUM

(75) Inventor: Tetsu Oishi, Yokohama-shi (JP)

(73) Assignee: CANON KABUSHIKI KAISHA, Tokyo (JP)

(21) Appl. No.: 13/361,837

(22) Filed: Jan. 30, 2012

(30) Foreign Application Priority Data
Feb. 9, 2011 (JP) 2011-026419
Dec. 7, 2011 (JP) 2011-268279

(51) Int. Cl. G06F 17/30

(52) U.S. Cl. 707/754; 707/736; 707/E17.019; 707/E17.059

(57) ABSTRACT

Data is input in a streaming format, a file is generated based on the input data in a streaming format, and data is output that includes reference information referring to the generated file.

### BACKGROUND OF THE INVENTION

1. Field of the Invention

The present invention relates to a data processing apparatus, a data processing method, and a storage medium.

2. Description of the Related Art

Japanese Patent Application Laid-Open No. 2006-338507 discusses a processing method that links a plurality of modules. Further, as a processing method that links a plurality of mountable modules, a filter pipeline system is known. In this filter pipeline system, the modules are handles as filters, and are connected by a pipeline.

There are various methods for transferring data between filters, such as successively sending data in a stream, or for a structured document, sending a component that is performed parsing based on a request from a latter-stage filter (document interface (I/F)). With a conventional Microsoft® extensible markup language (XML) paper specification (XPS) filter pipeline, the stream and the document can be specified based on inputs and outputs from each filter.

Since there are limitations on the data that can be handled by the Microsoft XPS filter pipeline, it is possible to specify the inputs and outputs for each filter. Since inputs are in XPS and outputs are in XPS or page description language (PDL), there are two types of inputs and outputs, the versatile stream I/F for PDL and the XPS-specific XPS document I/F.

However, when various types of file inputs and outputs are handled, since it takes time and effort to prepare each dedicated document I/F, it is more efficient to use the inputs and outputs in a versatile manner by preparing only streams. FIG. 12 is a schematic diagram illustrating data transfer in a stream. The data flowing in the stream is sequentially sent in a binary manner from the start.

However, when processing is performed based only on stream inputs and outputs, there are problems how the data is transferred when there is a plurality of outputs to one input and that the efficiency are poor when a data is returned in a stream despite that an entity file has already substantiated in the filter.

### SUMMARY OF THE INVENTION

The present invention is directed to improving the versatility and efficiency of the input and output of data to/from modules processing data.

According to an aspect of the present invention, a data processing apparatus includes an input unit configured to input data in a streaming format, a generation unit configured to generate a file based on the data in a streaming format input by the input unit, and an output unit configured to output data that includes reference information referring to the file generated by the generation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of a configuration of an information processing system.

FIG. 2 illustrates an outline of data processing in an information processing system.

FIG. 3 illustrates an example of a function configuration of an information processing apparatus.

FIG. 4 illustrates an example of a function configuration of a filter.

FIG. 5 is a flowchart illustrating an example of data processing.

FIG. 6 illustrates data transfer among filters.

FIG. 7 illustrates an example of a config file.

FIG. 8 illustrates an example of data transfer among filters as a list file.

FIG. 9A illustrates an example of a list file.

FIG. 9B illustrates an example of a list file when outputting a plurality of files.

FIG. 10 is a flowchart illustrating an example of determining an output method.

FIG. 11 illustrates an effect of a list file.

FIG. 12 is a schematic diagram illustrating data flowing in a stream.

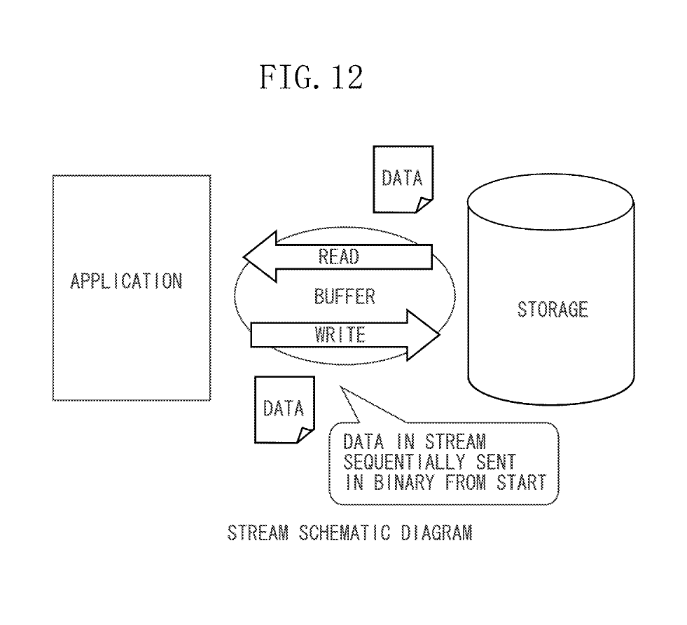

FIG. 13 illustrates an example of data output as a list file by a final filter.

FIG. 14 illustrates processing of an attached portable document format (PDF) (PDF portfolio).

FIG. 15 is an example of specifying whether a data format among filters is a file or a list file based on a config file.

### DESCRIPTION OF THE EMBODIMENTS

Various exemplary embodiments, features, and aspects of the invention will be described in detail below with reference to the drawings.

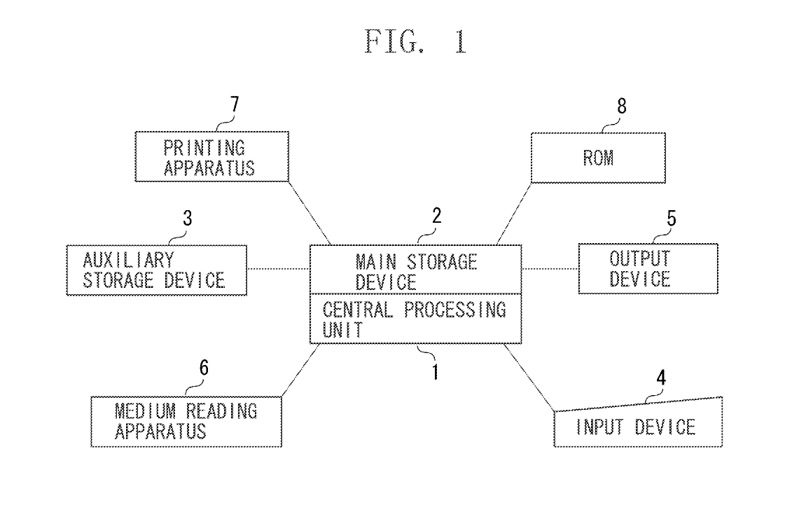

A first exemplary embodiment of the present invention will now be described. FIG. 1 illustrates an example of a configuration of an information processing system. A central processing unit 1 reads a storage medium, such as a floppy disk (FD), a compact disc read-only memory (CD-ROM), and an integrated circuit (IC) memory card, in which programs and relevant data are stored from a medium reading apparatus 6 connected to the system. Then, the central processing unit 1 processes information input from an input device 4 based on a system program or an application program loaded in a main storage device 2 from an auxiliary storage device 3, and outputs the processed information to an output device 5 or a printing apparatus 7. In the present exemplary embodiment, the output device 5 is a display device, such as a display, and is differentiated from the printing apparatus 7 included in the output device. The input device 4 is configured with a keyboard, a pointing device and the like. The auxiliary storage device 3 may be configured with a hard disk or a magneto optical disk, or may be configured with a combination of these. Further, these devices may be connected to each other via a network.

In the present exemplary embodiment, description will be made as follows, assuming that the information processing apparatus is configured, except for the printing apparatus 7, with the hardware units 1 to 8 that are illustrated in FIG. 1.

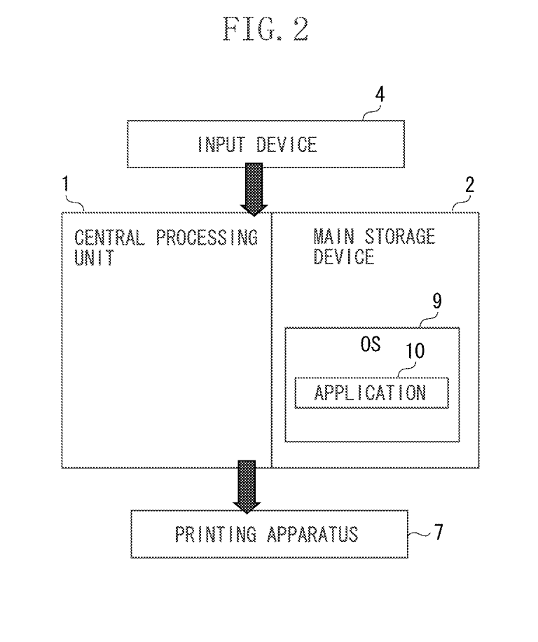

FIG. 2 illustrates an outline of data processing in an information processing system. Programs and relevant data stored in the auxiliary storage device 3, for example, are read by the central processing unit 1, a print command is input from the input device 4, data is sent to the printing apparatus 7, and printing is executed. The application (application software) functions under the control of an operating system (OS) executed by the central processing unit 1.

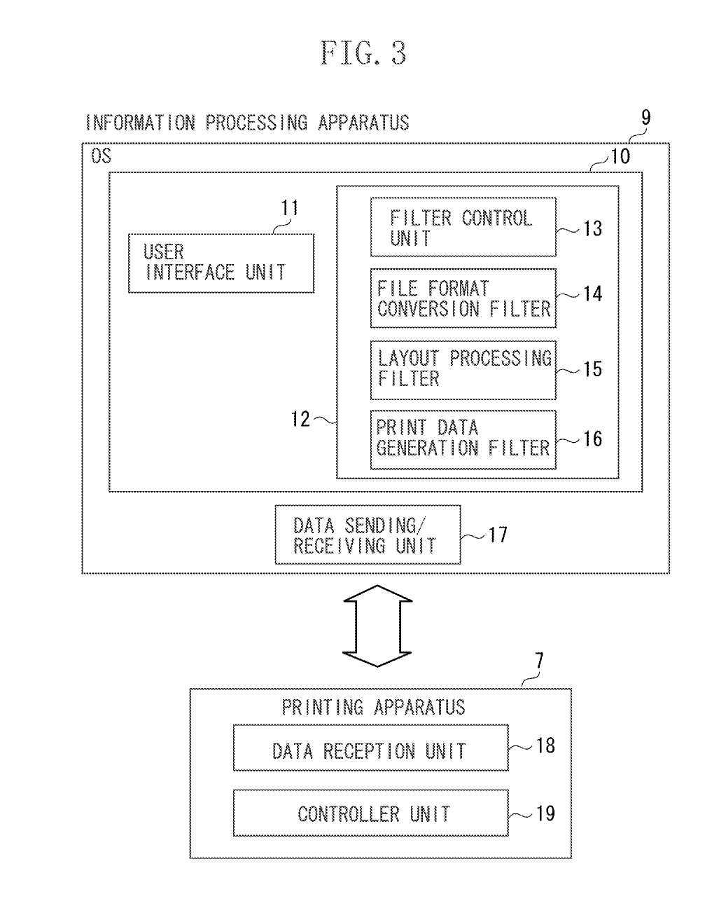

FIG. 3 illustrates an example of a function configuration of an information processing apparatus. An OS 9 controls the whole information processing apparatus. The OS 9 is connected to the printing apparatus 7 by a Centronics interface, a universal serial bus (USB), or a local area network interface. An application software 10 runs on the OS 9, and controls the printing apparatus 7.

A user interface unit 11 lets a user input various print settings such as setting to the printing apparatus, and instruct printing to start. A print data control unit 12 receives input data specified from the user interface unit 11, and generates data that can be processed by the printing apparatus 7.

A filter control unit 13 controls order and inputs and outputs of various filters. A file format conversion filter 14 is an example of a filter, which converts an Office® document into a PDF, for example.

A layout processing filter 15 is also an example of a filter, which performs layout processing, such as N-up, bookbinding, poster printing and the like. A print data generation filter 16 is also an example of a filter, which converts an input file such as a PDF into a printable PDL.

A data sending/receiving unit 17 is a part of the functions of the OS. The data sending/receiving unit 17 sends and receives data to/from the printing apparatus 7 via a Centronics interface, a USB, or a local area network connection. The printing apparatus 7 performs print processing based on an instruction from the connected information processing apparatus. The above-described a plurality of filters is an example of a plurality of modules.

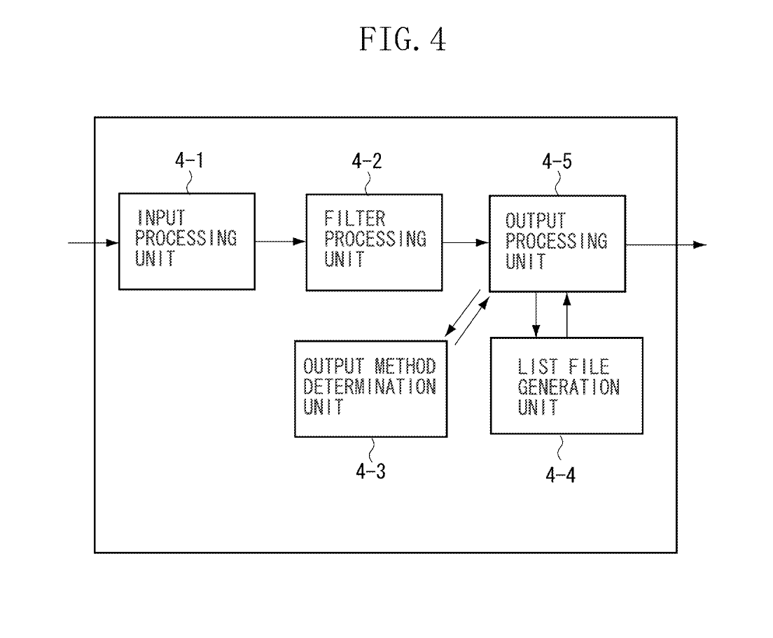

FIG. 4 illustrates an example of a function configuration of a filter. An input processing unit 4-1 receives a previous-stage filter output in a stream as input data. The input data may be a file per se (subject file), or a list file describing link information to a location where the file is substantiated.

A filter processing unit 4-2 performs the respective filter processes. Examples of filter processes include file format conversion, layout processing, and print data generation.

An output method determination unit 4-3 determines a determination method, i.e., whether to output a list file or a subject file.

A list file generation unit 4-4 generates a list file that describes link information to a file when it is determined by the output method determination unit 4-3 to output a list file. An output processing unit 4-5 outputs the output data reflecting the result of the filter processing unit 4-2, based on the determination result of the output method determination unit 4-3.

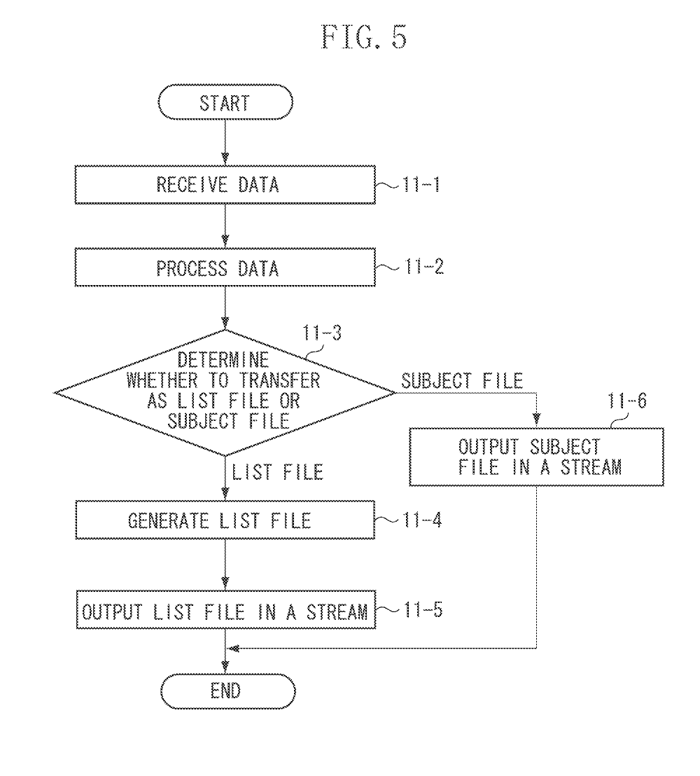

FIG. 5 is a flowchart illustrating an example of data processing. In step 11-1, the input processing unit 4-1 receives data from the filter control unit 13. In step 11-2, the filter processing unit 4-2 performs the processing of each filter, such as file format conversion and layout conversion. In step 11-3, the output method determination unit 4-3 determines whether to output a list file or a subject file. If it is determined to output a list file (“List File” in step 11-3), the processing proceeds to step 11-4. In step 11-4, the list file generation unit 4-4 generates a list file. In step 11-5, the output processing unit 4-5 outputs the generated list file in a stream. On the other hand, if it is determined by the output method determination unit 4-3 to output the subject file (“Subject File” in step 11-3), the processing proceeds to step 11-6. In step 11-6, the output processing unit 4-5 outputs the subject file in a stream.

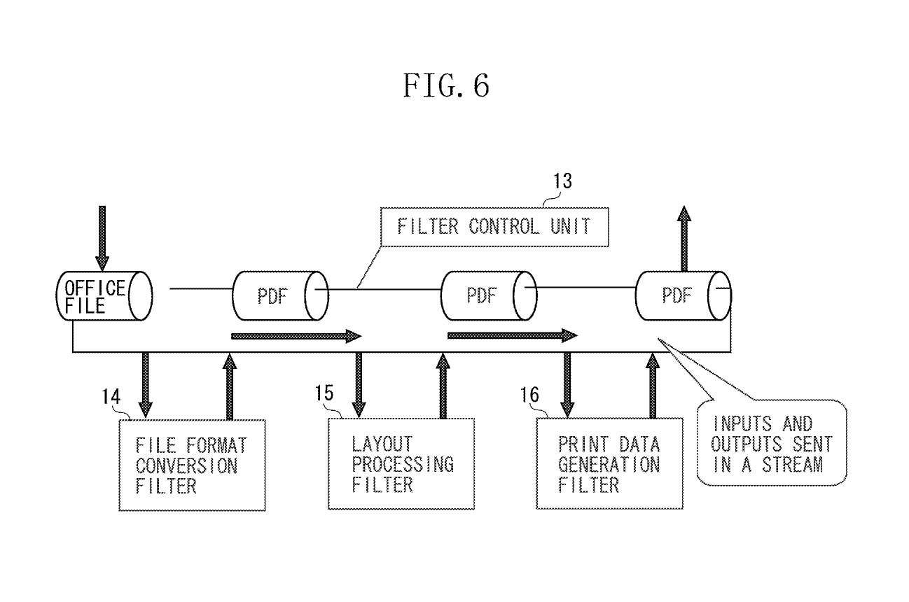

FIG. 6 illustrates the transfer of data among filters. The filter control unit 13 controls the filter order and data transfer. The filter control unit 13 reads the config file indicating the filter order and the data to be handled, and controls the filter order so that the previous-stage filter output becomes the latter-stage filter input.

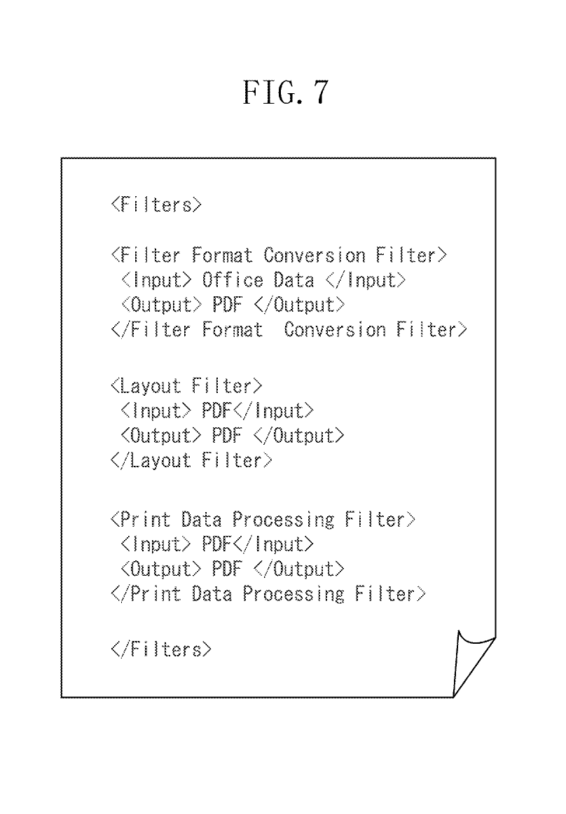

FIG. 7 illustrates an example of a config file. The config file is described in XML, for example. Each <Filter> element is described in the <Filters> element in the order in which they are to be linked. Each <Filter> element has an <Input> element and an <Output> element describing inputs and outputs. The config file illustrated in FIG. 7 indicates that a file format conversion filter, a layout filter, and a print data processing filter are linked in that order. Further, the config file describes that the file format conversion filter input is Office data and output is PDF, that the layout filter input is PDF and output is also PDF, and that the print data processing filter input is PDF and output is PDL.

A flow of a string of data will now be described. Office data is input into the print data control unit 12 based on a specification from the user interface unit 11 illustrated in FIG. 3. The Office data is then transferred to the filter control unit 13. The filter control unit 13 transfers the input Office data in a stream to the file format conversion filter 14, which is a first filter. The file format conversion filter 14 converts the Office data into a PDF, and transfers the converted file to the filter control unit 13 in a stream. The filter control unit 13 connects the previous-stage filter output as the latter-stage filter input. Consequently, the PDF file is transferred to the latter-stage layout processing filter 15 in a stream as an input. Similarly, after layout processing, the layout processing filter 15 transfers the PDF file in a stream to the filter control unit 13 as an output. The filter control unit 13 transfers this PDF file in a stream as an input file for the latter-stage print data generation filter 16. The print data generation filter 16 generates a PDL file from the PDF file, and transfers the generated PDL file in a stream to the filter control unit 13. The filter control unit 13 transfers this PDL file to the print data control unit 12 as a filter group output. The print data control unit 12 then sends the PDL file to the printing apparatus 7 via the data sending/receiving unit 17.

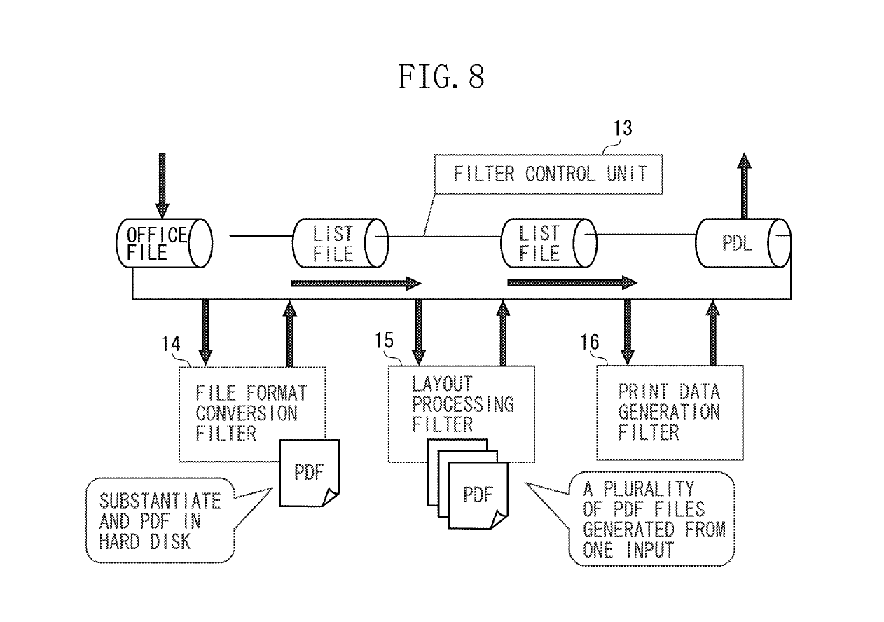

FIG. 8 illustrates an example of data transfer among filters as a list file. For example, when Office data is converted into a PDF file by the file format conversion filter 14, if the PDF file is substantiated and stored in the hard disk, transmitting the PDL file again in a stream is not very efficient. The data can be efficiently transferred by transferring just the list file describing the link information to the stored PDF file to the latter-stage filter in a stream.

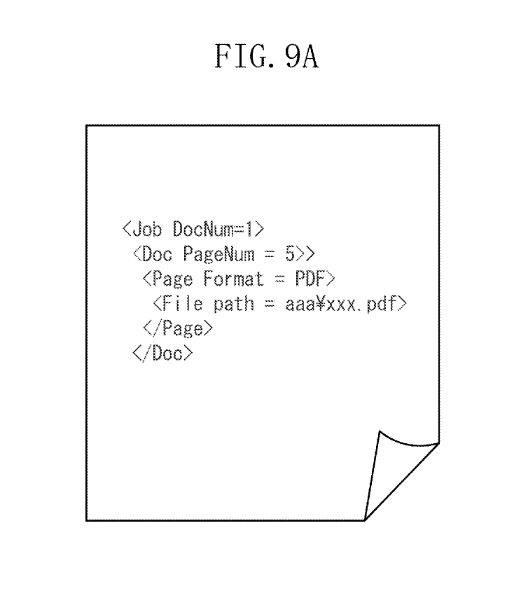

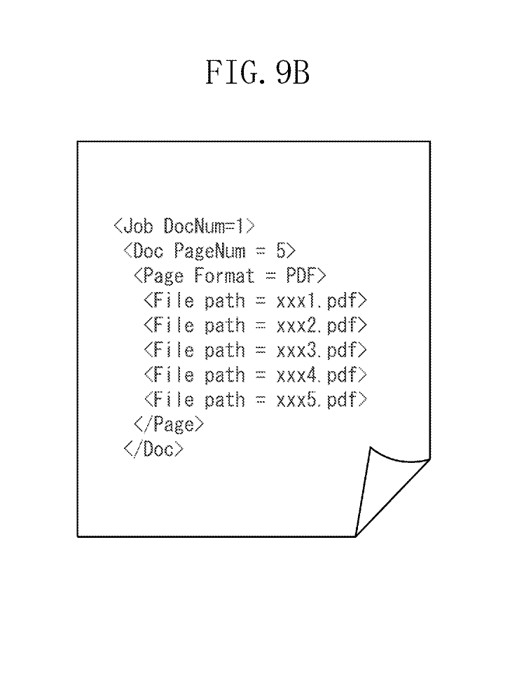

FIG. 9A illustrates an example of a list file. The list file is described in XML, for example. The list file includes a <Job> element, a <Doc> element, a <Page> element, and a <File> element. Link information to the substance file is described in the <File> element.

Further, a plurality of PDF files can be generated from one PDF file by the layout processing filter. In such a case, the plurality of files can also be efficiently processed by using a list file like that illustrated in FIG. 9B. FIG. 9B illustrates an example of a list file when outputting a plurality of files. For example, the fact that there is a plurality of files can be indicated by describing the <File> element a plurality of times in the <Page> element.

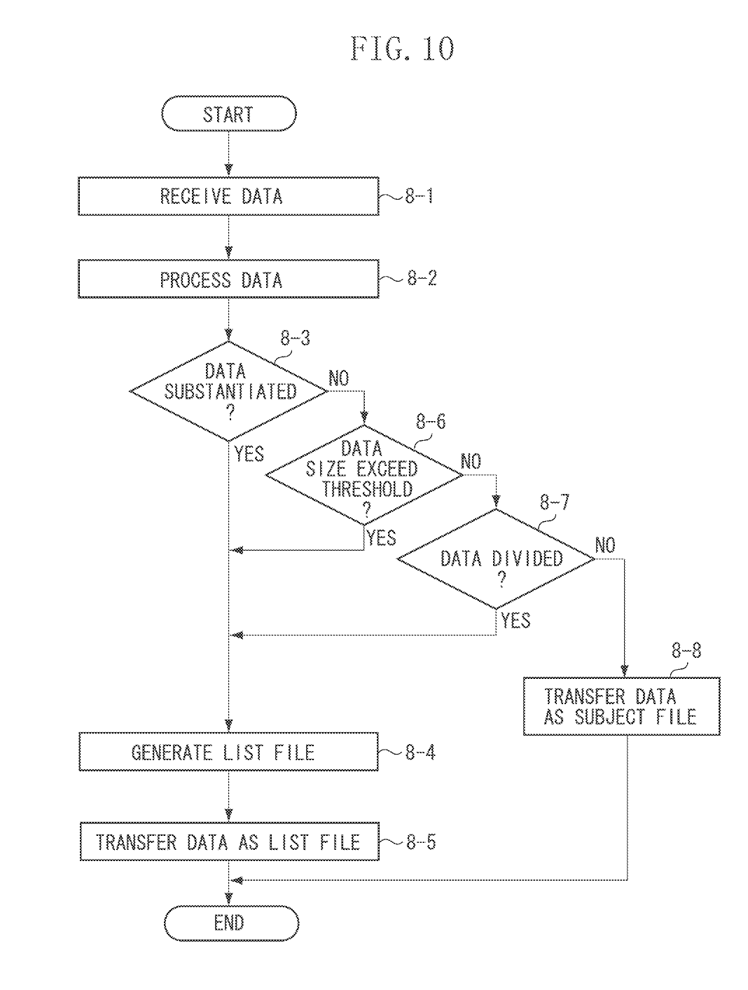

The method for determining whether to output a subject file or a file list will now be described with reference to the flowchart of FIG. 10. FIG. 10 is a flowchart illustrating an example of determining the output method.

In step 8-1, the input processing unit 4-1 receives data from the filter control unit 13. In step 8-2, the filter processing unit 4-2 performs the processing of each filter, such as file format conversion and layout conversion. In step 8-3, it is determined whether data is substantiated as a result of the processing. If it is determined that data is substantiated (YES in step 8-3), in step 8-4, the list file generation unit 4-4 generates a list file. Then, in step 8-5, the output processing unit 4-5 transfers the data as a list file to the filter control unit 13 in a stream. On the other hand, if it is determined that data is not substantiated (NO in step 8-3), in step 8-6, it is determined whether the data size exceeds a threshold. If the data size does not exceed the threshold, in step 8-7, it is determined whether the data has been divided. If it is determined that the data size exceeds a threshold (YES in step 8-6) or that the data has been divided (YES in step 8-7), the processing proceeds to step 8-4, and the list file generation unit 4-4 generates a list file. Then, in step 8-5, the output processing unit 4-5 transfers the list file to the filter control unit 13 in a stream. In other cases (i.e., if it is determined in step 8-7 that the data has not been divided (NO in step 8-7)), the processing proceeds to step 8-8. In step 8-8, the output processing unit 4-5 transfers the subject file to the filter control unit 13 in a stream.

Although in FIG. 10 an example is described in which the determination is based on all of steps 8-3, 8-6, and 8-7, the system may also be configured so that the determination concerning whether to transfer the data as a list file or as the subject file is based on just one of these steps. Further, the determination may also be performed by combining steps 8-3, 8-6, and 8-7 in an arbitrary manner.

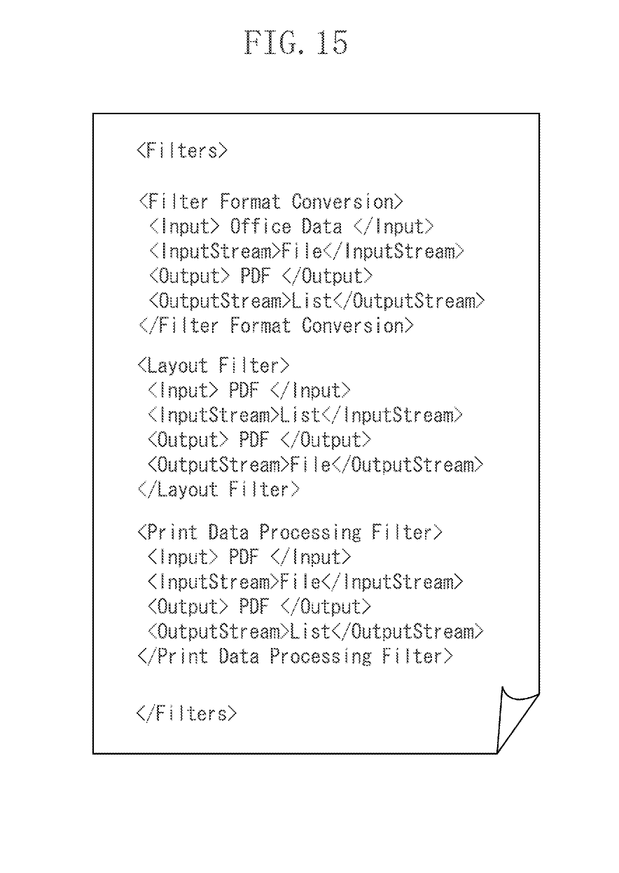

Further, whether to transfer the data as a list file or as the subject file can also be externally specified, for example by the config file, rather than determined internally by the output method determination unit 4-3. FIG. 15 is an example of specifying whether the inter-filter data format is the subject file or a list file based on the config file. The input to the file format conversion filter is a file configured as <InputStream>File</InputStream>, and the output is a list file configured as <OutputStream>List</OutputStream>. The input to the latter-stage layout filter is a list file, and the output is a file configured as <OutputStream>File</OutputStream>. The input to the final-stage print data filter is a list file, and the output is a list file configured as <OutputStream>List</OutputStream>. Thus, by specifying in the config file, the ultimately generated PDL can be output in a list file format even if it is only one file.

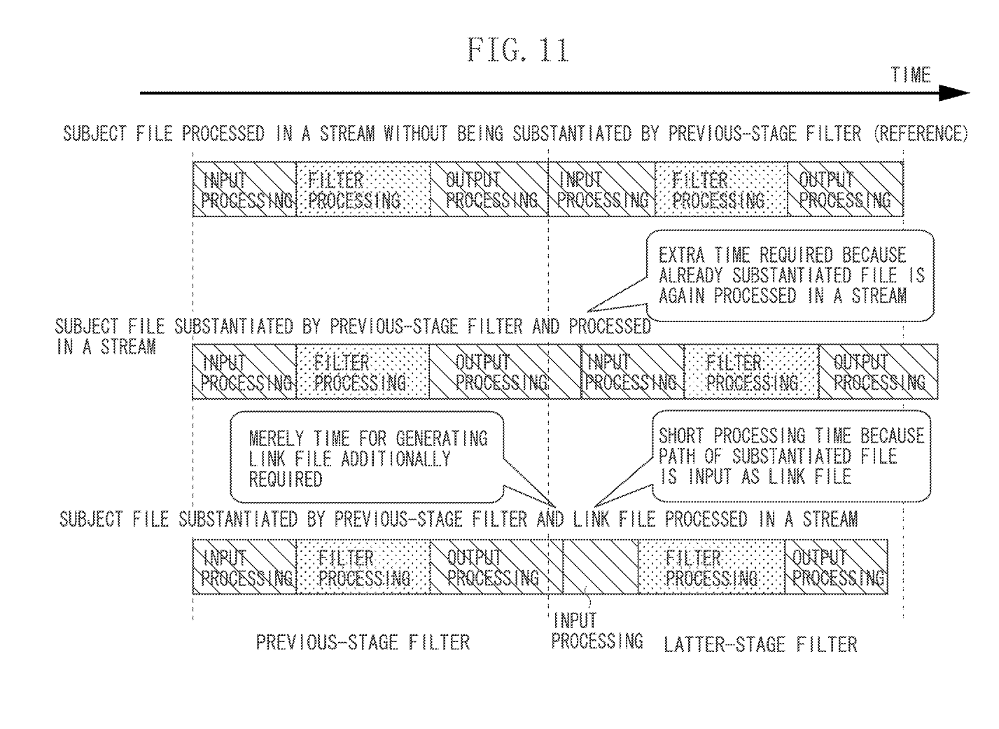

FIG. 11 illustrates the effects of a list file. In FIG. 11, the total processing time of two filters, a previous-stage filter and a latter-stage filter, are compared. A case in which “subject file processed in a stream without being substantiated by previous-stage filter” serves as a reference. Both the previous-stage filter and the latter-stage filter consist of input processing, filter processing, and output processing.

For a “subject file formed by a previous-stage filter and processed in a stream”, since the subject file temporarily substantiated on the hard disk based on the previous-stage filter output processing flows in a stream after having been read, more time is taken than for the reference. The processing time for the latter-stage filter is the same as the reference, so that overall the processing time increases by the increase in the previous-stage output processing time.

For a “subject file substantiated by previous-stage filter and link file processed in a stream”, since the list file is generated during the previous-stage filter processing time, this processing takes a little longer than for the reference. However, because there is no need to re-read from the hard disk, the processing time is shorter than for “formed by previous-stage filter and processed in a stream”. The input processing for the latter-stage filter can use an already-substantiated file just by reading the list file, so the processing time is less than for the reference. Overall, since the decrease in the input processing time for the latter-stage filter is greater than the increase in the output portion for the previous-stage filter, the processing time is less than for the reference.

Thus, according to the present exemplary embodiment, a plurality of output files can be processed. Further, since the processing can be performed efficiently, processing time decreases. The processing according to the present exemplary embodiment can be similarly performed even in a printer, rather than by a printer driver. More specifically, the same processing can be performed by the controller unit 19 illustrated in FIG. 3. In addition, the same processing can even be performed via a Web server or cloud computing.

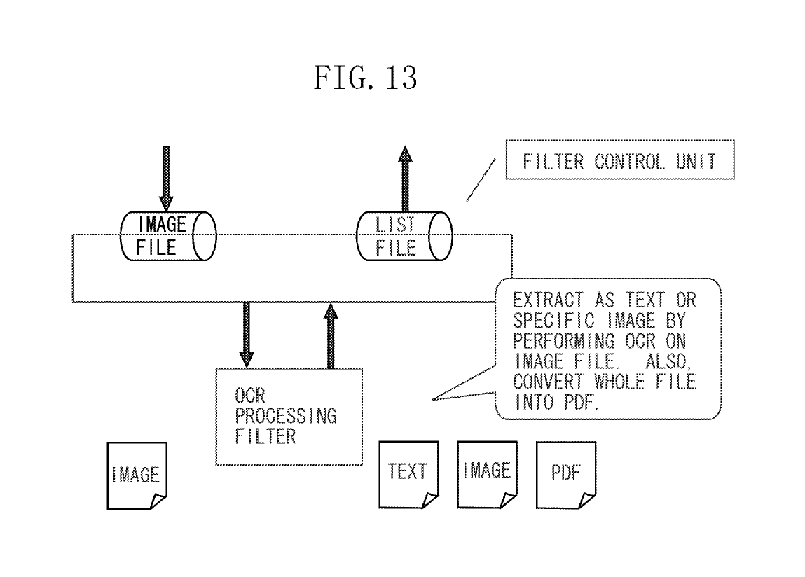

Another exemplary embodiment will now be described. FIG. 13 illustrates an example of optical character recognition (OCR) processing. The input to an OCR processing filter is an image file. The OCR processing filter extracts text or a specific image based on OCR processing. The OCR processing filter also performs, for example, processing for converting the whole input image into a PDF file. Since a plurality of files is generated, the output from the OCR processing filter is a list file describing link information to each of the files. When the OCR processing filter is a final-stage filter, the list file is the final output.

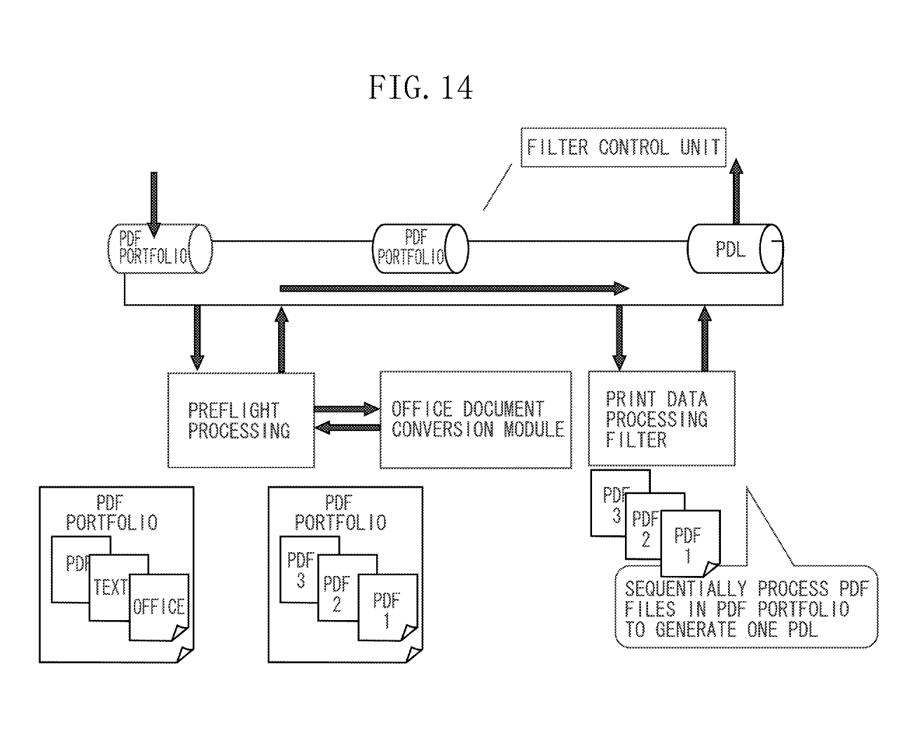

Yet another exemplary embodiment will now be described. FIG. 14 illustrates an example of processing of an attachment-containing PDF (PDF portfolio). A PDF can be in a format (called a PDF portfolio) in which Office documents or images are attached. A PDF portfolio processing method will now be described. To process a PDF portfolio, a preflight processing filter is used. A preflight processing filter is a filter for pre-checking whether a latter-stage filter can perform processing without any problems. When a PDF portfolio is input, the preflight processing filter confirms the format of an attached file. If the attached file format is other than PDF, the preflight processing filter converts the attached file into a PDF using an Office document conversion module, for example. Even if a PDF portfolio is input in the print data processing filter, since the attached files are all PDFs, the same processing as that for a normal PDF can be performed. A PDL for each attached PDF can be generated or the PDFs can also be combined to generate one PDL.

According to each of the above exemplary embodiments, data input and output among a plurality of modules that process data can be made more versatile and efficient.

### Other Embodiments

Aspects of the present invention can also be realized by a computer of a system or apparatus (or devices such as a central processing unit (CPU) or a microprocessor unit (MPU)) that reads out and executes a program of computer executable instructions recorded on a memory device to perform the functions of one or more of the above-described embodiments, and by a method, the steps of which are performed by the computer of the system or apparatus by, for example, reading out and executing the program recorded on a memory device to perform the functions of the aforementioned one or more of the above-described embodiments. For this purpose, the program can be provided to the computer for example via a network or from a recording medium of various types serving as the memory device (e.g., computer-readable storage medium). In such a case, the system or apparatus, and the recording medium where the program is stored, are included as being within the scope of the present invention. The computer-readable medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-026419 filed Feb. 9, 2011, and Japanese Patent Application No. 2011-268279 filed Dec. 7, 2011, each of which is hereby incorporated by reference herein in its entirety.

What is claimed is:

1. A data processing apparatus comprising:
an input unit configured to input data in a streaming format;
a generation unit configured to generate a file based on the data in a streaming format input by the input unit; and
an output unit configured to output data that includes reference information referring to the file generated by the generation unit.

2. The data processing apparatus according to claim 1, further comprising a plurality of filters,
wherein one of the filters includes the input unit, the generation unit, and the output unit.

3. The data processing apparatus according to claim 1, wherein the generation unit is configured to generate a plurality of files based on the data in a streaming format input by the input unit.

4. The data processing apparatus according to claim 3, wherein the plurality of files includes an image file and a text file extracted from the image file.

5. The data processing apparatus according to claim 3, wherein the plurality of files is generated from an attachment-containing file.

6. A method for processing data comprising:
inputting data in a streaming format;
generating a file based on the input data in a streaming format; and
outputting data that includes reference information referring to the generated file.

7. The method for processing data according to claim 6, wherein a data processing apparatus carrying out the method for processing data comprises a plurality of filters, and
wherein one of the filters performs the inputting, the generating, and the outputting.

8. The method for processing data according to claim 6, wherein a plurality of files are generated based on the input data in a streaming format.

9. The method for processing data according to claim 8, wherein the plurality of files includes an image file and a text file extracted from the image file.

10. The method for processing data according to claim 8, wherein the plurality of files is generated from an attachment-containing file.

11. A storage medium storing a program that causes a computer to execute:
inputting data in a streaming format;
generating a file based on the input data in a streaming format; and
outputting data that includes reference information referring to the generated file.

12. The storage medium according to claim 11, wherein the computer comprises a plurality of filters, and
wherein one of the filters performs the inputting, the generating, and the outputting.

13. The storage medium according to claim 11, wherein a plurality of files is generated based on the input data in a streaming format.

14. The storage medium according to claim 13, wherein the plurality of files includes an image file and a text file extracted from the image file.

15. The storage medium according to claim 13, wherein the plurality of files is generated from an attachment-containing file.
